(19) United States
(12) Patent Application Publication
(10) Pub. No.: US 2017/0044819 A1
(43) Pub. Date: Feb. 16, 2017

(54) Pressure-Sealed Door For A High-Speed Rail Vehicle

(71) Applicant: SIEMENS AKTIENGESELLSCHAFT, MUENCHEN (DE)

(72) Inventor: AXEL KRUEGER, KREFELD (DE)

(21) Appl. No.: 15/306,600

(22) PCT Filed: Mar. 31, 2015
(86) PCT No.: PCT/EP2015/057003

§ 371 Date: Oct. 25, 2016

(30) Foreign Application Priority Data
May 2, 2014 (DE) 102014208288.9

(51) Int. Cl. E06B 7/205; B61D 23/02; B61D 19/02

(52) U.S. Cl. CPC E06B 7/205; B61D 19/02; B61D 23/02

(57) ABSTRACT

A vehicle, in particular a passenger rail vehicle, has at least one door. In the area of the door, the vehicle has a sealing web which is arranged on a floor of the vehicle and can be moved at least between a sealing state and an open state, such that, in the sealing state, the sealing web projects out of the floor and forms a sealing surface for sealing off the closed door with respect to the interior of the vehicle, and that, in the open state, the sealing web is recessed in the floor.

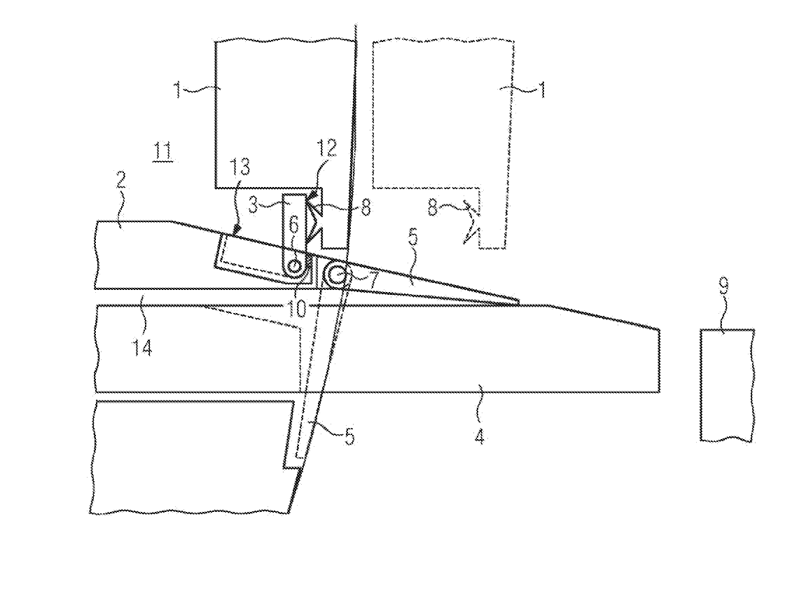

The invention relates to a vehicle with an entry door in a boarding area of the vehicle.

Entry doors with a pressure-sealed design are known in high-speed rail vehicles. For example, an inflatable sealing system is used to seal the doors by means of compressed air. These systems are regarded as expensive to construct.

The problem addressed by the invention is that of proposing a simple, cost-effective device for the pressure-sealing of vehicle doors.

The problem is solved by the subject matter of the independent patent claim 1. Developments and embodiments of the invention are reproduced in the features of the dependent patent claims.

A vehicle according to the invention, in particular a passenger rail vehicle, in particular a high-speed vehicle, comprises at least one door, in particular an entry door in a boarding area of the vehicle. The entry door may also be referred to as an outer door which closes off the interior of the vehicle from the vehicle environment when the door is in the closed state and opens it up when the door is in the open state.

According to the invention, the vehicle comprises at least one sealing web, so that the door is in future sealed in the floor area, said sealing web being arranged in the area of the door and therefore particularly in the boarding area of the vehicle and being movable on a floor of the vehicle in such a manner that it is movable at least between a sealing and an open state, so that in the sealing state it projects from the floor and forms a sealing surface for sealing the closed door in respect of the vehicle interior and it is recessed in the floor in the open state.

The sealing surface is suitable for the abutment of a seal, in particular a door seal, and for sealing the closed door in respect of the vehicle interior.

The sealing web in this case is arranged on the floor in a vertically displaceable manner, for example, or is arranged pivotably on the floor.

The invention allows there to be a vertical sealing surface for the abutment of a horizontally acting seal and, nevertheless, a continuous boarding area.

In a development, it is arranged pivotably on the floor in such a manner that the sealing surface of the sealing web acts as a stepping surface of the floor in the open state. The sealing web is recessed in the floor in such a manner that in the open state the sealing surface ends flush with the parts of the floor directly abutting it and, in particular, forms a level section.

The sealing surface of the sealing web is developed to be vertically oriented in the sealing state and is suitable for the abutment of a horizontally acting seal. In particular, the door comprises a seal of this kind which is prestressed in the sealed state between the sealing surface of the sealing web and door, particularly in a horizontal direction. The door seal according to an exemplary embodiment is arranged on a side of the door facing the vehicle interior. A double-lip seal could be used as the seal, for example. The sealing surface, as the bearing surface of the double-lip seal, could then particularly be at least 40 mm in the vertical direction.

In accordance with one embodiment, the door is configured as a sliding/swing door. Compared with its closed state, it is offset from the vehicle in the open state.

In order for the sealing web to be sealed against the floor, the floor may comprise a further seal which is prestressed in the sealing state between the sealing web and the floor. It is preferably arranged in a recess in the floor, in which the sealing web can be recessed. In particular, it is arranged in such a manner that it acts in a prestressed manner in a horizontal direction between a vertically running internal wall of the floor recess and the sealing surface of the sealing web.

In a development, the sealing web is arranged about a horizontal shaft arranged pivotably on the vehicle floor. In particular, the further seal for sealing the sealing web against the floor is arranged in the area of this horizontal pivot.

Alternatively, however, it is also conceivable for the sealing web to be arranged on the floor in a vertically displaceable manner. Its sealing surface in this case may, in turn, run vertically or it runs substantially horizontally. A vertically running sealing surface would be recessed in the floor in the open state. The horizontal sealing surface, on the other hand, would likewise act as the stepping surface of the floor in the open state. The seal would then act vertically, however, between the sealing web and the door. A horizontally acting seal is advantageous. Here, too, however, the levelness of the floor would be possible in both cases.

A method of sealing the door of the vehicle according to the invention in the floor area is correspondingly characterized in that the sealing web is moved from the open state into the sealing state and the door is moved from the open state into the closed state, in order to pre stress the seal between the door and the sealing web.

In order to allow barrier-free boarding or alighting from the vehicle, the door is moved from the closed state into the open state and, similarly, the sealing web is moved from the sealing state into the open state.

A further development of the invention can be seen in that the vehicle according to the invention comprises at least one stepping platform for bridging a gap in a horizontal direction between the boarding area of the vehicle and a platform, which stepping platform is arranged in a boarding area of the rail vehicle and can be displaced linearly, particularly in a horizontal direction, wherein the rail vehicle comprises a recess for receiving the stepping platform which is arranged below a floor in a boarding area of the rail vehicle, wherein it comprises a flap which is arranged pivotably on the floor of the rail vehicle, such that said flap closes the recess for receiving the stepping platform when said stepping platform is in an inserted state and wherein the flap acts as a ramp between the floor and the stepping platform when said stepping platform is in the extended state.

In the inserted state, the stepping platform is arranged in the body of the vehicle below a floor in a boarding area of the vehicle. The corresponding recess is provided there. The recess is closed in the inserted state by the pivotable flap, particularly such that the flap is flush with the outer skin of the vehicle. It closes off the body of the vehicle outwardly. For this purpose, in a development the flap is mounted rotatably about a horizontal shaft on the floor. The shaft in this case is located in the area of a front end of the vehicle facing the platform or turned away from the interior of the vehicle.

In order to form a ramp between the floor and the stepping platform when the stepping platform is in the extended state, the flap is shaped accordingly. The flap exhibits a wedge-shaped cross section, for example.

The flap performs two functions simultaneously. On the one hand, it is used to close off the recess for receiving the retractable step. On the other hand, it acts as a ramp for balancing the floor level with the stepping surface level of the stepping platform. Said level may, in turn, be the same height as a platform level. The advantage lies in the step-free alignment of the individual levels, making it easier to board the vehicle and alight from it.

The invention allows numerous embodiments. It is explained in greater detail with the help of the following FIGURE, in which an exemplary embodiment is depicted.

A rail vehicle for passenger transport is schematically depicted in partial cross section in the FIGURE. The rail vehicle comprises an entry door 1 for opening and closing an interior 11 of the rail vehicle which is arranged in a boarding area of the rail vehicle. Furthermore, it comprises a sealing web 3. The door 1 is movably configured between a closed and an open state. The sealing web 3 is likewise movably configured between a sealing and an open state.

Both the closed state of the door 1 and also the sealing state of the sealing web 3 are depicted with continuous lines, while the open state of the door 1 and the open state of the sealing web 3 are depicted with dotted lines.

In the sealing state, the sealing web 3 forms a sealing surface 12 for a seal 8 of the door 1, said sealing web sealing the closed door 1 in respect of the interior 11 of the vehicle. The seal 8 in this case is configured as a double-lip seal.

In order to seal the closed door 1 in respect of the interior 11 of the vehicle, the seal 8 is prestressed between the sealing surface 12 of the sealing web 3 and the door 1. The seal acts in a horizontal direction.

The sealing web 3 is arranged pivotably about the horizontal shaft 6 on the floor 2. In the open state, the sealing web 3 is folded in and recessed in the floor 2. In the sealing state, on the other hand, the sealing web 3 is folded out and projects from the floor 2. The same surface of the sealing web, which acts as a sealing surface 12 in the sealing state, in this case acts as the stepping surface 13 of the floor 2 in the open state. In accordance with this embodiment, the sealing web 3 is completely recessed in the floor 2 and ends flush therewith, so that the floor is barrier-free in the boarding area, at least in the area of the sealing web 3.

Apart from the seal 8 between the door 1 and the sealing web 3, a further seal 10 is provided in this case which acts in the sealing state of the sealing web 3 between the sealing web 3 and the floor 2 and is correspondingly arranged between the sealing web 3 and the floor 2 and prestressed. The seal 10 is arranged on the floor 2 in a positionally fixed manner. It is located, both in the sealing and also in the open state of the sealing web 3, at the same point viewed relatively to said sealing web.

The vehicle may comprise a door frame, against which the door is otherwise sealed, in particular against which the door is leaned and is prestressed where necessary with further seals inserted in between.

Furthermore, the rail vehicle in this exemplary embodiment comprises a stepping platform 4 for bridging a gap in a horizontal direction between the boarding area of the vehicle and a platform 9 that can be displaced linearly in a horizontal direction. In order to receive the stepping platform 4 in the body of the vehicle, the rail vehicle comprises a recess 14 which is arranged below the floor 2 in the boarding area of the rail vehicle. Moreover, a flap 5 is provided which is mounted pivotably about a horizontal shaft 7 on the floor 2 of the rail vehicle in such a manner that, in an inserted state of the stepping platform 4, the flap 5 closes the recess 14 for receiving the stepping platform 4 and that, in an extended state of the stepping platform 4, the flap 5 acts as a ramp between the floor 2 and the stepping platform 4.

In the inserted state, which is depicted by a dotted line, the flap 5 ends the body of the vehicle flush with the outer skin of the vehicle directly surrounding the flap 5.

The extended state is drawn with continuous lines. The flap 5 acts as a ramp for balancing the floor level of the floor of the vehicle and the stepping surface level of the stepping platform 4. In this case, the stepping platform 4 has, in addition, a wedge-shaped area on its front end facing the platform 9, in order to align the stepping surface level of the stepping platform 4 with the platform level. Again, everything is step-free.

1-11. (canceled)

12. A vehicle, comprising:
at least one door;
a floor; and
a sealing web disposed in a region of said door, said sealing web is disposed on said floor of the vehicle and is movable at least between a sealing state and an open state, so that in the sealing state said sealing web projects from said floor and forms a sealing surface for sealing a closed door in respect of a vehicle interior and that said sealing web is recessed in said floor in the open state.

13. The vehicle according to claim 12, wherein said sealing web is disposed pivotably on said floor.

14. The vehicle according to claim 12, wherein said sealing web ends flush with a part of said floor directly surrounding said sealing web in the open state.

15. The vehicle according to claim 12, wherein said sealing surface of said sealing web is vertically oriented in the sealing state.

16. The vehicle according to claim 12, wherein said door has a further seal for abutment with said sealing surface of said sealing web in the sealing state.

17. The vehicle according to claim 16, wherein said further seal is configured as a double-lip seal.

18. The vehicle according to claim 12, wherein said door is a sliding/swing door.

19. The vehicle according to claim 12, wherein said floor is level in the open state of said sealing web in said region of said sealing web.

20. The vehicle according to claim 12, further comprising:
at least one stepping platform for bridging a gap in a horizontal direction between a boarding area of the vehicle and a platform, said stepping platform is disposed in said boarding area of the rail vehicle and can be displaced linearly;
a rail vehicle body having a recess formed therein for receiving said stepping platform and disposed below said floor in said boarding area of the rail vehicle; and
a flap disposed pivotably on said floor of the rail vehicle, such that said flap closes the recess for receiving said stepping platform when said stepping platform is in an inserted state and said flap acts as a ramp between said floor and said stepping platform when said stepping platform is in an extended state.

21. The vehicle according to claim 20, wherein said stepping platform can be displaced in a horizontal direction.

22. The vehicle according to claim 20, further comprising a horizontal shaft, said flap is mounted rotatably about a horizontal shaft on said floor.

23. The vehicle according to claim 12, wherein the vehicle is a passenger rail vehicle.
